(19) United States
(12) Patent Application Publication
(10) Pub. No.: US 2018/0084122 A1
(43) Pub. Date: Mar. 22, 2018

(54) PROCESSING DEVICE, IMAGE FORMING APPARATUS, AND NON-TRANSITORY COMPUTER READABLE MEDIUM

(71) Applicant: FUJI XEROX CO., LTD., Tokyo (JP)

(72) Inventor: Yusuke KAMOI, Kanagawa (JP)

(73) Assignee: FUJI XEROX CO., LTD., Tokyo (JP)

(21) Appl. No.: 15/437,923

(22) Filed: Feb. 21, 2017

(30) Foreign Application Priority Data
Sep. 16, 2016 (JP) 2016-181375

(51) Int. Cl. H04N 1/00

(52) U.S. Cl. CPC H04N 1/00389; H04N 2201/0094; H04N 1/00424; H04N 1/00411

(57) ABSTRACT

A processing device includes a receiver, an execution unit, and a generator. The receiver receives selection of first processing to be executed and a setting for executing the first processing from a user. The execution unit executes the first processing. The generator generates, when the first processing is executed, second processing for re-executing the first processing. The content of the second processing generated by the generator when the first processing has succeeded is different from the content of the second processing generated by the generator when the first processing has failed.

### CROSS-REFERENCE TO RELATED APPLICATIONS

This application is based on and claims priority under 35 USC 119 from Japanese Patent Application No. 2016-181375 filed Sep. 16, 2016.

### BACKGROUND

### (i) Technical Field

The present invention relates to a processing device, an image forming apparatus, and a non-transitory computer readable medium.

### (ii) Related Art

On a display of a processing device, a list of operations that are executable by an apparatus including this processing device may be displayed as an image. Normally, a user selects one of the operations to be executed from the list. This list is constituted by processing selectors arranged on the display, such as icons, related to predetermined operations. The user touches one of the processing selectors, such as an icon, to select an operation to be executed.

### SUMMARY

According to an aspect of the invention, there is provided a processing device including a receiver, an execution unit, and a generator. The receiver receives selection of first processing to be executed and a setting for executing the first processing from a user. The execution unit executes the first processing. The generator generates, when the first processing is executed, second processing for re-executing the first processing. The content of the second processing generated by the generator when the first processing has succeeded is different from the content of the second processing generated by the generator when the first processing has failed.

### BRIEF DESCRIPTION OF THE DRAWINGS

Exemplary embodiments of the present invention will be described in detail based on the following figures, wherein:

FIG. 1 is a block diagram illustrating an example of the hardware configuration of an image forming apparatus;

FIG. 2 illustrates an example of an image displayed on an operation panel;

FIG. 3 is a block diagram illustrating an example of the functional configuration of a controller;

FIGS. 4A and 4B are a flowchart illustrating an operation performed by the controller in a first exemplary embodiment;

FIGS. 5A and 5B illustrate icons of one touch apps displayed on a display panel; and

FIGS. 6A and 6B are a flowchart illustrating an operation performed by the controller in a second exemplary embodiment.

### DETAILED DESCRIPTION

### (Overall Configuration of Image Forming Apparatus)

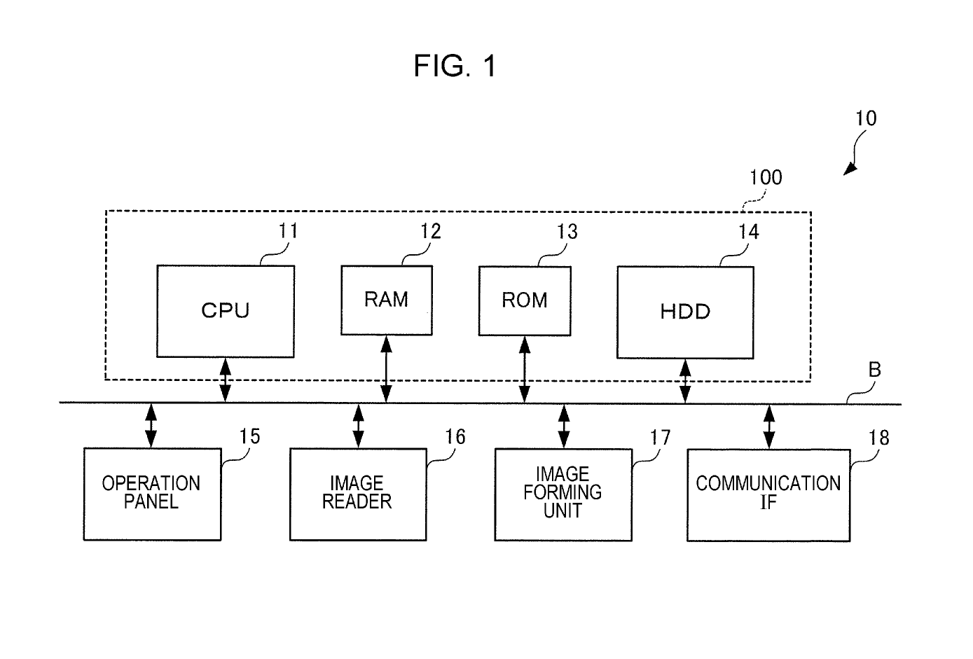

FIG. 1 is a block diagram illustrating an example of the hardware configuration of an image forming apparatus 10.

The image forming apparatus 10 forms an image on a recording medium, such as paper, and outputs the recording medium as a printed material. The image forming apparatus 10 has a printing function and also has other image processing functions such as a scanning function and a fax sending and receiving function.

As shown in FIG. 1, the image forming apparatus 10 includes a central processing unit (CPU) 11, a random access memory (RAM) 12, a read only memory (ROM) 13, a hard disk drive (HDD) 14, an operation panel 15, an image reader 16, an image forming unit 17, and a communication interface (IF) 18. These elements send and receive data with each other via a bus B.

The CPU 11 loads various programs stored in the ROM 13, for example, into the RAM 12, and executes the loaded programs so as to implement functions described below.

The RAM 12 is used as a work memory for the CPU 11.

The ROM 13 is a memory which stores various programs executed by the CPU 11.

The HDD 14 is a magnetic disk drive, for example, which stores image information read by the image reader 16 and image information used for forming an image by the image forming unit 17.

The operation panel 15 is a touch panel, for example, which displays various items of information and receives input of an operation from a user.

The image reader 16 reads an image recorded on a document. The image reader 16 is a scanner, for example, and may be a charge coupled device (CCD) scanner or a contact image sensor (CIS) scanner. In a CCD scanner, light applied to a document from a light source and reflected by the document is reduced by a lens and is received by CCDs. In a CIS scanner, light sequentially applied to a document from light emitting diode (LED) light sources and reflected by the document is received by a CIS.

The image forming unit 17 is an example of a print mechanism which forms an image on a recording medium. The image forming unit 17 is a printer, for example, for forming an image based on an electrophotographic system or an inkjet method. In the electrophotographic system, an image is formed by transferring toner attached to a photoconductor drum to a recording medium, such as a sheet. In the inkjet method, an image is formed by ejecting ink onto a recording medium.

The communication IF 18 sends and receives various items of data with other devices via a network.

In the exemplary embodiments, the CPU 11, the RAM 12, the ROM 13, and the HDD 14 form a controller (processing device) 100 which controls the individual elements of the image forming apparatus 10.

### (Operation of Image Forming Apparatus 10)

By using the above-described image forming apparatus 10, a user can make a copy of a document, for example. More specifically, the image reader 16 reads a document and generates image information concerning the document, and based on this image information, the image forming unit 17 forms an image on a recording medium. The user can also perform printing as a result of sending a print job to the image forming apparatus 10 by using an external device (not shown), such as a personal computer (PC), via the communication IF 18 and a network (not shown), such as a local area network (LAN), connected to the image forming apparatus 10. More specifically, the image forming unit 17 forms an image on a recording medium based on image information indicated by the print job. The user can also perform fax sending and receiving. More specifically, the user can send image information about a document read by the image reader 16 via a network and the communication IF 18. The user can also scan a document. More specifically, the user can store image information about a document read by the image reader 16 in an external device via a network and the communication IF 18.

### (Operation Panel 15)

The operation panel 15 will be discussed in detail.

As discussed above, the operation panel 15 is a touch panel, for example. Forming the operation panel 15 as a touch panel allows various items of information, such as image forming conditions of the image forming apparatus 10, to be displayed on the touch panel. The user touches the touch panel to input various items of information such as image forming conditions.

The operation panel 15 is operated as follows.

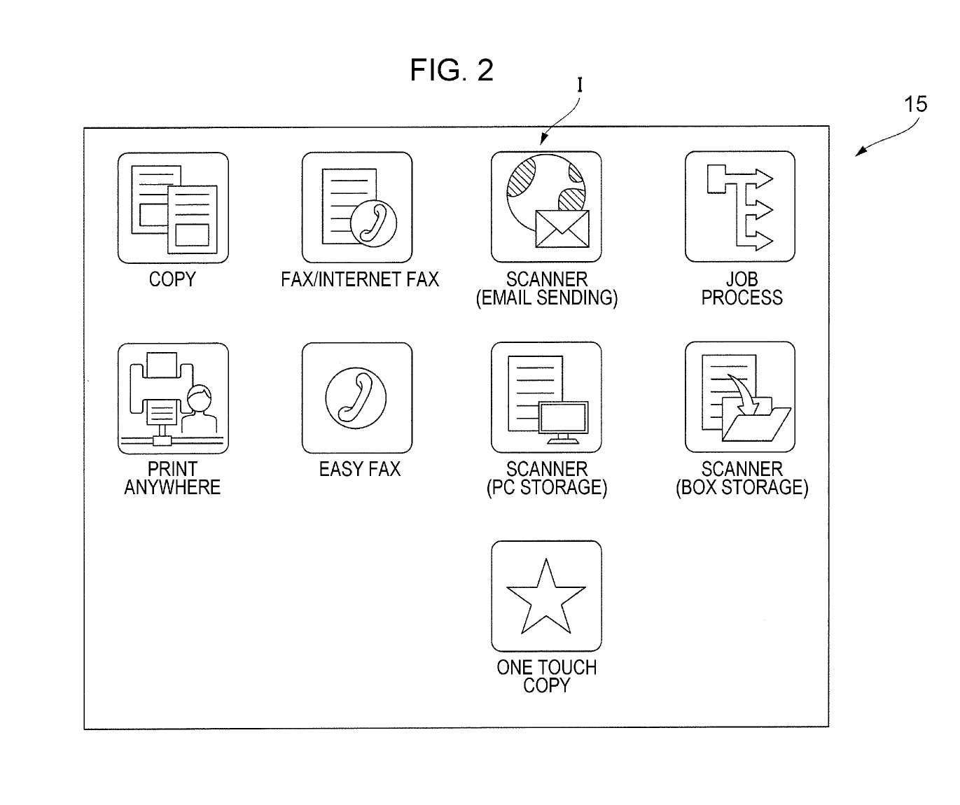

FIG. 2 illustrates an example of an image displayed on the operation panel 15.

On the operation panel 15, a list of icons I used for performing functions of the image forming apparatus 10 is displayed as an image. The image displayed on the operation panel 15 represents a so-called home screen. The icons I are examples of processing selectors that are related to predetermined operations. When one of the processing selectors is selected, it executes the related processing.

In the example shown in FIG. 2, the operation panel 15 displays icons I representing functions such as copy, fax/Internet fax, scanner (email sending), job process, print anywhere, easy fax, scanner (PC storage), scanner (box storage), and one touch copy. These functions form a list of icons I.

To use a desired function, the user performs a selecting operation for selecting one of the icons I.

In this case, the user simply touches an icon I to select a desired function. When the user touches an icon I, a setting screen for the function related to the touched icon I is displayed. Touching the icon I “copy”, for example, displays a setting screen for instructing the user to set settings for making a copy of a document, such as the number of copies, the type of sheet, the enlargement or reduction ratio, and whether to perform monochromatic or color printing. After setting these settings, the user presses a start button (not shown), for example, to start the copy operation.

The operation panel 15 serves as a display that displays icons (processing selectors) I.

In the exemplary embodiments, the icon I “one touch copy” is a so-called one touch app. A one touch app is created as a result of a user setting desirable settings in advance for processing to be executed. That is, when a one touch app is created, it means that settings selected by the user for processing to be executed, such as the number of copies and the type of sheet, are already set. Then, by touching the icon I “one touch copy”, the user can execute the processing speedily. Preparing one touch apps saves the time and efforts for the user to set complicated settings every time the user executes processing. There are two types of one touch apps. In one type, when the user touches an icon I, a job immediately starts (direct execution). In the other type, when the user touches an icon I, a check screen is first displayed, and after the user checks the screen and presses a start button, a job starts (checked execution).

To create a one touch app, a user is required to set settings, such as the number of copies and the type of sheet, in advance. There may a situation where the user registers wrong settings for certain processing without knowing correct settings, and as a result, when the user touches the one touch app, the processing fails with these wrong settings. When the user executes such a one touch app, the execution is terminated and the user is required to input settings all over again. In the case of fax sending, for example, inputting of a wrong address may make it necessary for the user to input a correct address again.

To address such a situation, in the exemplary embodiments, when processing has succeeded, settings set by a user are registered, and when processing has failed, settings set by the user are changed. This configuration saves the time and efforts for the user.

The configuration of the controller 100 that implements this operation will be described below.

### (Controller 100)

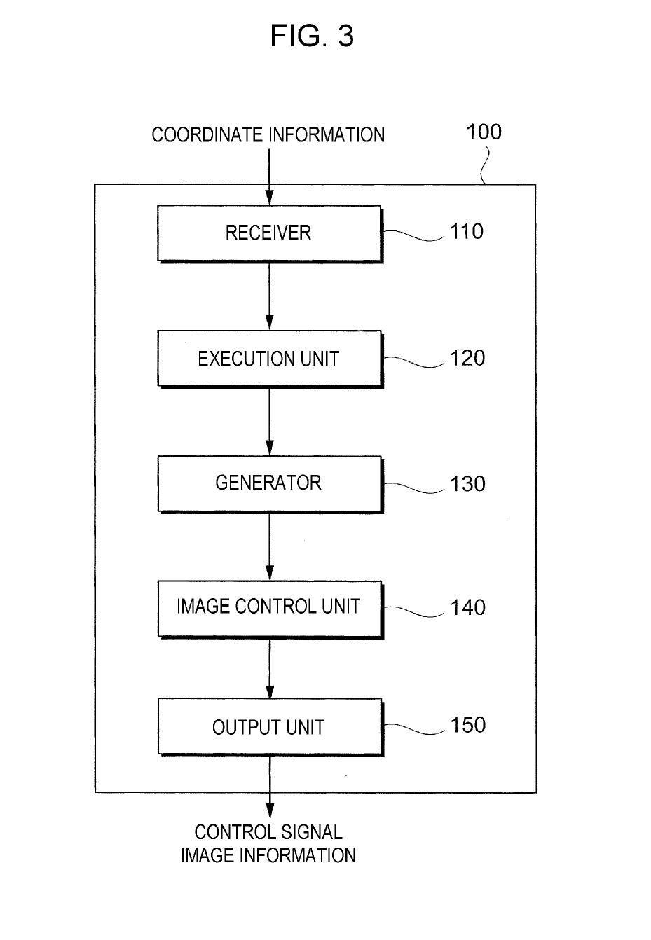

FIG. 3 is a block diagram illustrating an example of the functional configuration of the controller 100. In FIG. 3, among various functions of the controller 100, functions only related to the exemplary embodiments are shown.

As shown in FIG. 3, the controller 100 includes a receiver 110, an execution unit 120, a generator 130, an image control unit 140, and an output unit 150.

The receiver 110 receives the selection of first processing and settings for executing the first processing from a user. The first processing is processing that the user wishes to perform in the image forming apparatus 10. The first processing is, for example, processing related to one of the icons I shown in FIG. 2, such as copy or fax/Internet fax. If the first processing concerns “copy”, for example, settings for executing the first processing are the number of copies, the type of sheet, the enlargement or reduction ratio, whether to perform monochromatic or color copying. In this case, the receiver 110 obtains coordinate information from the operation panel 15. The coordinate information indicates the position on the operation panel 15 at which a finger of the user, for example, is touching. Then, the receiver 110 detects which icon I is being selected, based on the coordinate information. The receiver 110 also determines whether to receive the selection from the user in accordance with the type of operation performed by the user. More specifically, the receiver 110 determines whether the operation performed by the user is a touch operation or a push and holding operation, based on the obtained coordinate information. In the case of a touch operation, the receiver 110 receives the selection from the user. In the case of a push and holding operation, the receiver 110 performs a different operation, such as displaying of a help screen.

As described above, the user may perform printing as a result of sending a print job to the image forming apparatus 10 from an external device, such as a PC. In this case, the first processing is a job for performing this printing operation.

The receiver 110 also receives the selection of second processing. In the exemplary embodiments, the second processing is generated as a one touch app, which will be discussed in detail later. To execute the second processing, the user performs an operation such as touching a one touch app. The receiver 110 then receives the selection of a one touch app from the user.

When the receiver 100 receives the selection of an icon I, the execution unit 120 executes processing related to this icon I. More specifically, the execution unit 120 outputs a control signal to the individual elements of the image forming apparatus 10 to control them, thereby implementing processing selected by the user.

In the case of scanning processing, for example, the execution unit 120 executes reading processing to read an image of a document by controlling the image reader 16. The execution unit 120 then executes image processing on the read image and outputs the resulting image information from the output unit 150. The output unit 150 will be discussed later. In the case of copying processing, the execution unit 120 executes reading processing to read an image of a document by controlling the image reader 16. The execution unit 120 then executes image processing on the read image and outputs the resulting image information to the image forming unit 17. The execution unit 120 then performs printing by controlling the image forming unit 17.

When the execution unit 120 has executed the first processing, the generator 130 generates second processing (one touch app) for re-executing the first processing. In this case, the content of second processing (one touch app) 120 generated when the first processing has succeeded is different from that when the first processing has failed. That is, the one touch app generated when the first processing has succeeded is different from that when the first processing has failed. This will be discussed in detail later. The generator 130 also generates an icon I related to the second processing. In this case, an icon I generated when the first processing has succeeded is different from an icon I generated when the first processing has failed.

The image control unit 140 controls the displaying of an image on the operation panel 15. That is, the image control unit 140 generates image information indicating an image such as that shown in FIG. 2, and outputs the generated image information from the output unit 150. Then, an image such as that shown in FIG. 2 is displayed on the operation panel 15.

The output unit 150 outputs a control signal to each of the elements of the image forming apparatus 10. The output unit 150 also outputs image information if necessary.

Operations performed by the controller 100 will be described below in greater detail. Different operations performed by the controller 100 will be described in first and second exemplary embodiments.

### First Exemplary Embodiment

In the first exemplary embodiment, after executing the first processing, the controller 100 generates a one touch app, which is the second processing, in accordance with whether the first processing has succeeded or failed. The generation of a one touch app will be described below.

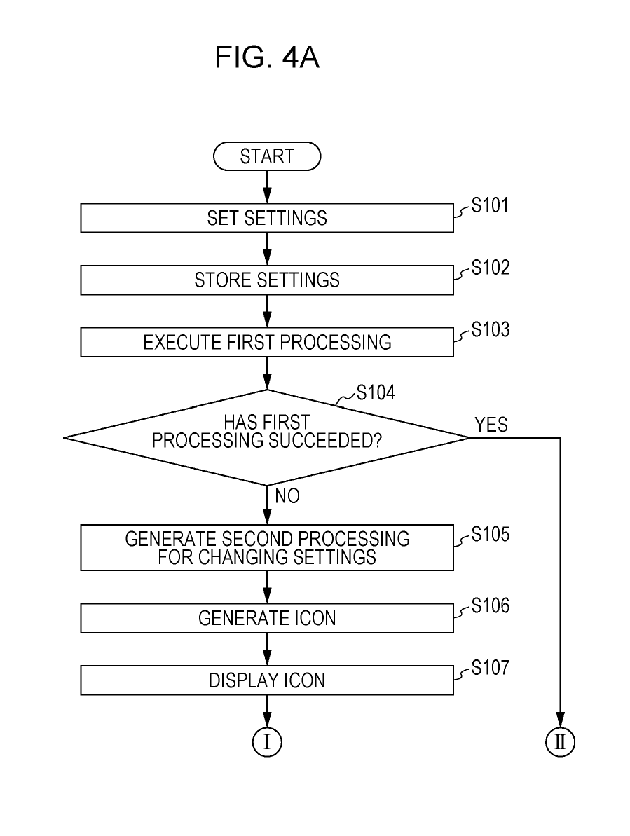

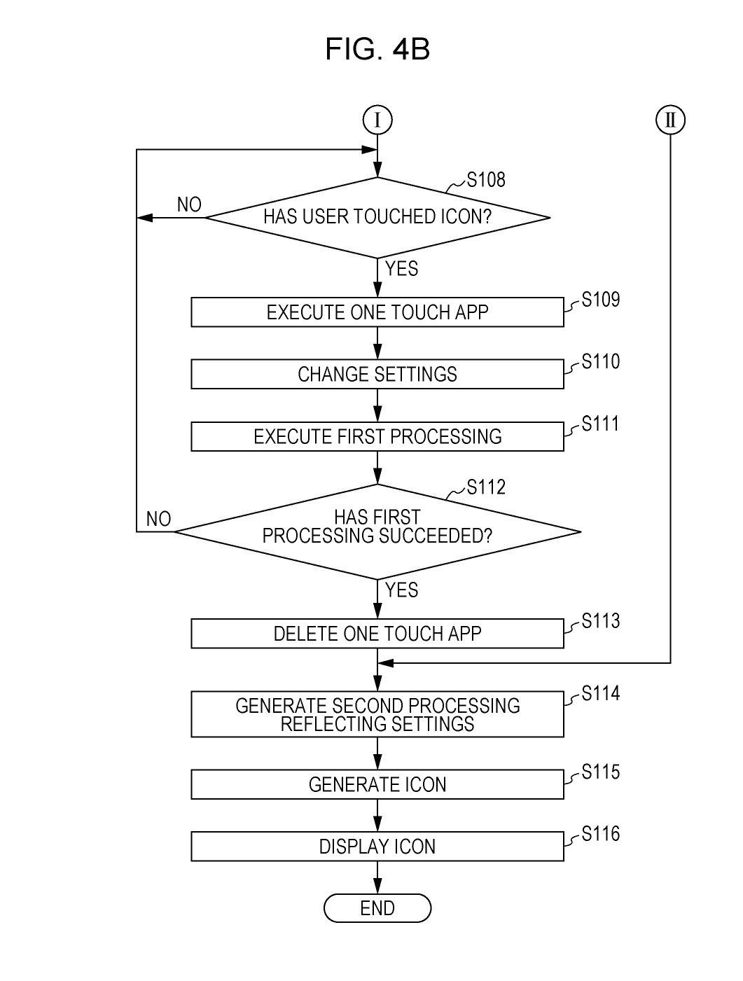

FIG. 4 is a flowchart illustrating an operation performed by the controller 100 in the first exemplary embodiment.

In step S101, a user first sets settings for executing the first processing. As discussed above, the first processing is processing that the user wishes to perform, for example, “copy”. In this case, the user operates the operation panel 15 to set settings such as the number of copies, the type of sheet, the enlargement or reduction ratio, and whether to perform monochromatic or color copying.

To set settings for executing the first processing, as discussed above, the user touches an icon I shown in FIG. 2 to display a setting screen and operates this setting screen. In step S102, the receiver 110 receives the settings set by the user and stores them.

In step S103, the user presses a start button, for example, and then, the first processing related to the icon I touched by the user is executed. In this case, the execution unit 120 executes the first processing.

In step S104, the generator 130 determines whether the first processing has succeeded or failed.

If the first processing has failed (NO in step S104), in step S105, the generator 130 generates second processing for changing the settings. That is, the generator 130 generates a new one touch app for changing the settings set in step S101. If the first processing is “copy”, the second processing is a one touch app for modifying the settings such as the number of copies, the type of sheet, the enlargement or reduction ratio, and whether to perform monochromatic or color copying.

If only a portion of the first processing has failed, the generator 130 may generate second processing for changing settings for this portion. For example, if the first processing is fax sending processing or sending of a scanned document and if sending has failed for some of plural destinations, only the addresses of the destinations for which sending has failed are changed. The generator 130 thus creates a one touch app for changing the settings for the addresses of the destinations for which sending has failed.

The generator 130 may generate second processing in accordance with the situation how the first processing has failed. For example, if fax sending performed as the first processing fails because a sending destination is occupied, there is no need to check the address of the sending destination again. The generator 130 thus creates a one touch app for implementing direct execution. In contrast, if fax sending fails because of the wrong address of a destination, the user has to check the address of the destination again. The generator 130 thus creates a one touch app for implementing checked execution.

In step S106, the generator 130 also generates an icon I related to the one touch app generated in step S105.

In step S107, the image control unit 140 displays the icon I of the one touch app generated by the generator 130 on the operation panel 15.

In step S108, the receiver 110 determines whether the user has touched the icon I of the one touch app displayed on the operation panel 15 in step S107. If the user has touched the icon I, the receiver 110 receives the selection of the icon I from the user.

If the user has not touched the icon I (NO in step S108), the controller 100 returns to step S108.

If the user has touched the icon I (YES in step S108), the execution unit 120 executes the one touch app (second processing) in step S109. In this case, the execution unit 120 directly executes the one touch app (direct execution).

The one touch app is used by the user to change the settings set in step S101. In step S110, the user operates the operation panel 15 to modify the settings. The receiver 110 receives the operation performed by the user.

After modifying the settings, in step S111, the user presses a start button, for example, and the execution unit 120 re-executes the first processing.

Then, in step S112, the generator 130 determines whether the first processing has succeeded or failed.

If the first processing has succeeded (YES in step S112), in step S113, the generator 130 deletes the one touch app (second processing) created in step S105. That is, the generator 130 deletes the second processing generated when the first processing has failed if the first processing which is re-executed after the setting is changed by using the second processing succeeds.

If the first processing has failed again (NO in step S112), the one touch app (second processing) generated in step S105 is maintained, and the controller 100 returns to step S108.

After step S113 or if the first processing has succeeded in step S104 (YES in step S104), in step S114, the generator 130 generates second processing, which is the first processing reflecting the settings. That is, based on the settings stored in step S102, the generator 130 generates a one touch app reflecting the settings set in step S101 or S110. If the first processing is “copy”, the second processing is a one touch app in which settings such as the number of copies, the type of sheet, the enlargement or reduction ratio, and whether to perform monochromatic or color copying are set and stored.

In step S115, the generator 130 also generates an icon I related to the one touch app generated in step S114.

In step S116, the image control unit 140 displays the icon I of the one touch app generated by the generator 130 on the operation panel 15.

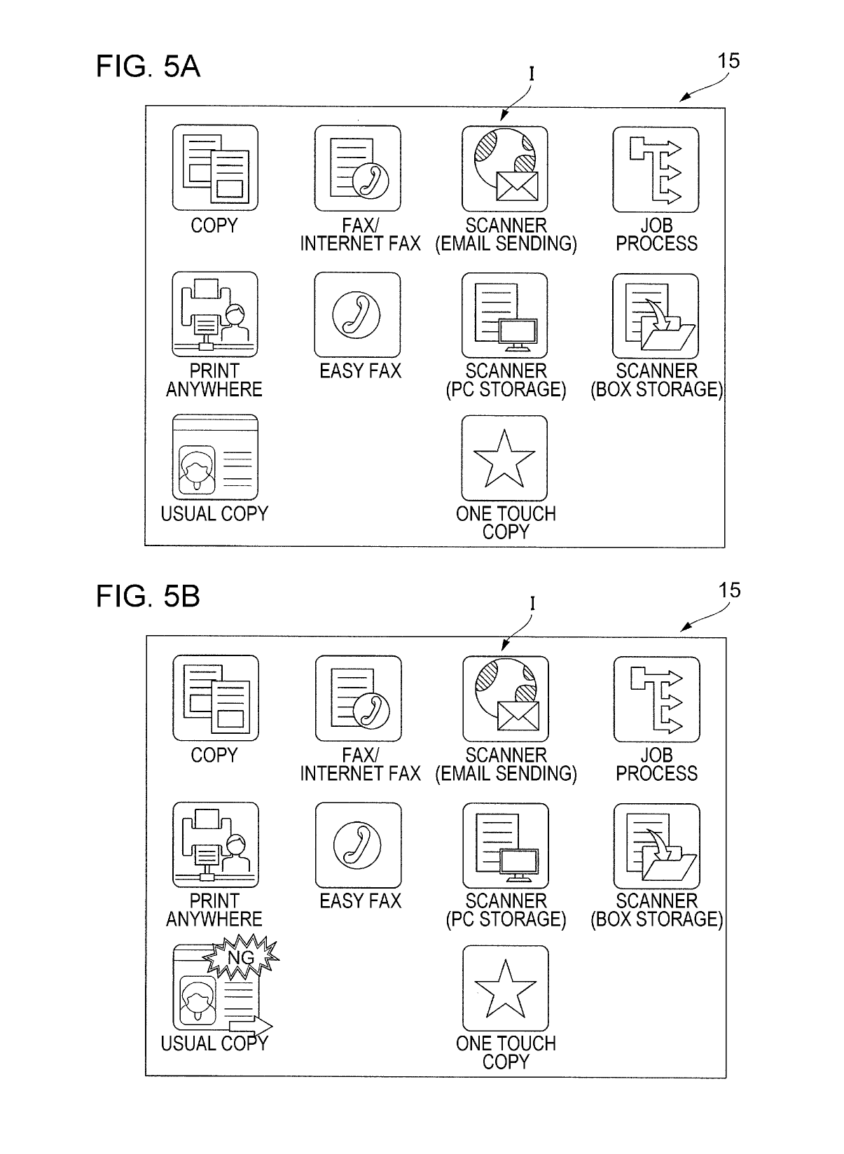

FIGS. 5A and 5B illustrate icons I of one touch apps displayed on the display panel 15 in steps S116 and S107.

FIG. 5A illustrates icons I of one touch apps displayed on the operation panel 15 in step S116 when the first processing has succeeded.

In FIG. 5A, in addition to the icons I shown in FIG. 2, a new icon I “usual copy” is generated and displayed. The design and the name of this icon I shown in FIG. 5A are only examples, and the user can specify them as desired.

FIG. 5B illustrates icons I of one touch apps displayed on the operation panel 15 in step S107 when the first processing has failed.

In FIG. 5B, as well as in FIG. 5A, in addition to the icons I shown in FIG. 2, a new icon I “usual copy” is generated and displayed. To distinguish the icon I in FIG. 5B from that in FIG. 5A, the design of the icon I is changed and appended with “NG”. Then, the user can be informed that the settings need changing. The arrow in the icon I in FIG. 5B indicates that this one touch app is an app for direct execution.

### Second Exemplary Embodiment

In the second exemplary embodiment, a one touch app, which is the second processing, is generated without waiting for the completion of the first processing.

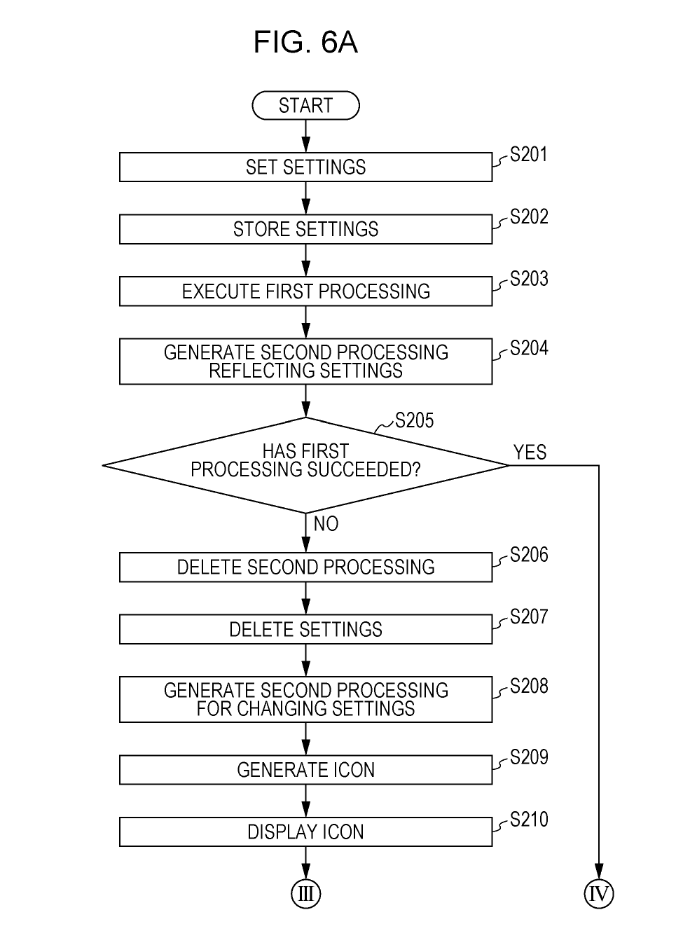

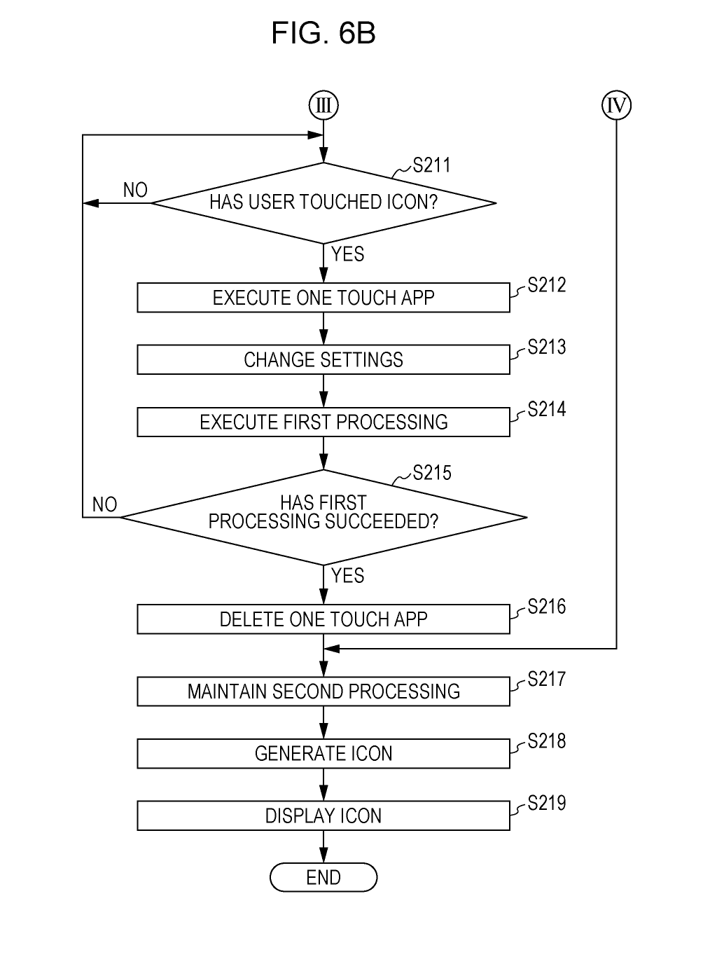

FIGS. 6A and 6B are a flowchart illustrating an operation performed by the controller 100 in the second exemplary embodiment.

Steps S201 through S203 are similar to steps S101 through S103 in FIG. 4A, and an explanation thereof will thus be omitted.

After step S203, in step S204, the generator 130 generates second processing, which is the first processing reflecting the settings. That is, the generator 130 generates a new one touch app reflecting the settings set in step S201 without waiting for the completion of the first processing.

In step S205, the generator 130 determines whether the first processing has succeeded or failed.

If the first processing has failed (NO in step S205), in step S206, the generator 130 deletes the second processing generated in step S204. That is, in step S206, the generator 130 deletes the one touch app reflecting the settings of the first processing. In step S207, the generator 130 also deletes the settings stored in step S202. As a result, information concerning the settings including errors is deleted.

In step S208, the generator 130 generates second processing for changing the settings. That is, the generator 130 generates a new one touch app for changing the settings set in step S201.

In step S209, the generator 130 also generates an icon I related to the one touch app generated in step S208.

In step S210, the image control unit 140 displays the icon I of the one touch app generated by the generator 130 on the operation panel 15.

Steps S211 through S216 are similar to steps S108 through S113 in FIG. 4B.

After step S216 or if the first processing has succeeded in step S205 (YES in step S205), in step S217, the generator 130 maintains the second processing (one touch app) generated in step S208 or S204.

In step S218, the generator 130 also generates an icon I related to the one touch app generated in step S208 or S204.

In step S219, the image control unit 140 displays the icon I of the one touch app generated by the generator 130 on the operation panel 15.

In the above-described image forming apparatus 10, when first processing has succeeded, the settings set by the user are registered. Then, a one touch app is generated or maintained as second processing for executing the first processing with these settings. Thereafter, by executing this one touch app, the user is able to execute processing reflecting the settings selected by the user.

When first processing has failed, a one touch app, which is second processing for changing the settings set by the user, is generated. By executing this one touch app, the user is able to easily change the settings.

In the exemplary embodiments of the invention, when processing has succeeded, settings set by a user are registered, and when processing has failed, settings set by the user are not registered but are changed. It is thus possible to easily determine the content of settings to be registered.

When executing a one touch app generated when first processing has failed, the user changes settings only for a portion of the first processing which has failed. The user is thus able to easily recognize a portion for which the settings have to be changed and also to change the settings with less effort. Additionally, different one touch apps may be generated in accordance with the situation how the first processing has failed. When checking by the user is not necessary, a one touch app may be directly executed, thereby enhancing the ease of operation for the user. If the first processing succeeds after the settings have been changed, the generated one touch app is automatically deleted, thereby further reducing the time and effort for the user. The user recognizes that the one touch app has been deleted and thus understands that the first processing has succeeded.

In the above-described exemplary embodiments, a one touch app is generated as second processing and is displayed as an icon I, which serves as an example of the processing selector, on the display panel 15. With the use of a one touch app, the corresponding icon I for executing this one touch app is displayed on a home screen such as that shown in FIG. 2, so that the user can immediately recognize that the one touch app has been created. The user can also execute this one touch app by a simple operation. However, an icon I is generated for a one touch app registering one setting based on a one-to-one correspondence, which may increase the number of icons I displayed on the home screen.

The second processing is not restricted to a one touch app. An app implementing default value register or preset register, for example, may be created and displayed as an icon I. In default value register, a setting is registered as a default value. Default value register is effective particularly when there is only one setting to be used. In preset register, multiple settings are registered together, and a user selects one of the settings. If such an app is used, only one icon I is required for the registration of multiple settings. Preset register is effective when the user does not wish to display many icons I on a home screen such as that shown in FIG. 2.

In the above-described exemplary embodiments, a one touch app is automatically generated. Alternatively, a check screen for instructing a user to select whether to generate a one touch app may be displayed. Alternatively, a screen for instructing a user to select whether to execute a one touch app, default value register, or preset register may be displayed.

In the above-described exemplary embodiments, the processing device is applied to the image forming apparatus 10 by way of example. However, the processing device may be applicable to a device which is capable of displaying application software icons side by side, such as a mobile phone, a smartphone, and a tablet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing device comprising:
a receiver that receives selection of first processing to be executed and a setting for executing the first processing from a user;
an execution unit that executes the first processing; and
a generator that generates, when the first processing is executed, second processing for re-executing the first processing,
wherein the content of the second processing generated by the generator when the first processing has succeeded is different from the content of the second processing generated by the generator when the first processing has failed.

2. The processing device according to claim 1, wherein, when the first processing has succeeded, the generator generates the second processing, which is the first processing reflecting the setting, and when the first processing has failed, the generator generates the second processing for changing the setting.

3. The processing device according to claim 1, wherein the generator generates the second processing, which is the first processing reflecting the setting, and when the first processing has succeeded, the generator maintains the second processing, and when the first processing has failed, the generator generates the second processing for changing the setting.

4. The processing device according to claim 2, wherein, when a portion of the first processing has failed, the generator generates the second processing for changing the setting for the portion of the first processing which has failed.

5. The processing device according to claim 3, wherein, when a portion of the first processing has failed, the generator generates the second processing for changing the setting for the portion of the first processing which has failed.

6. The processing device according to claim 2, wherein the second processing generated when the first processing has failed is deleted if the first processing which is re-executed after the setting is changed by using the second processing succeeds.

7. The processing device according to claim 3, wherein the second processing generated when the first processing has failed is deleted if the first processing which is re-executed after the setting is changed by using the second processing succeeds.

8. The processing device according to claim 2,
wherein:
the receiver stores the setting; and
the generator deletes the stored setting when the first processing has failed.

9. The processing device according to claim 3,
wherein:
the receiver stores the setting; and
the generator deletes the stored setting when the first processing has failed.

10. The processing device according to claim 1, wherein the generator also generates a processing selector which is related to the second processing and which executes the second processing when the processing selector is selected, and the processing selector generated when the first processing has succeeded is different from the processing selector generated when the first processing has failed.

11. The processing device according to claim 10, further comprising:
an image control unit that controls displaying of the processing selector as an image on a display.

12. An image forming apparatus comprising:
an image forming unit that forms an image on a recording medium; and
a controller that controls the image forming apparatus,
the controller including
a receiver that receives selection of first processing to be executed and a setting for executing the first processing from a user,
an execution unit that executes the first processing, and
a generator that generates, when the first processing is executed, second processing for re-executing the first processing,
wherein the content of the second processing generated by the generator when the first processing has succeeded is different from the content of the second processing generated by the generator when the first processing has failed.

13. A non-transitory computer readable medium storing a program causing a computer to execute a process, the process comprising:
receiving selection of first processing to be executed and a setting for executing the first processing from a user;
executing the first processing; and
generating, when the first processing is executed, second processing for re-executing the first processing,
wherein the content of the second processing generated when the first processing has succeeded is different from the content of the second processing generated when the first processing has failed.
